(19) United States
(12) Patent Application Publication
(10) Pub. No.: US 2010/0032929 A1
(43) Pub. Date: Feb. 11, 2010

(54) AUTOMOTIVE VEHICLE SEAT WITH AN AIRBAG IN THE BACKREST THEREOF

(75) Inventor: Donia Razazi, Madrid (ES)

Correspondence Address: LADAS & PARRY LLP, 26 WEST 61ST STREET, NEW YORK, NY, 10023, US

(73) Assignee: DALPHI METAL ESPANA, S.A., Madrid (ES)

(21) Appl. No.: 11/922,262

(22) PCT Filed: Jun. 17, 2005
(86) PCT No.: PCT/EP2005/052832

§ 371 Date: Oct. 20, 2009

(51) Int. Cl. B60R 21/207; B60R 21/16

(52) U.S. Cl. 280/730.2

(57) ABSTRACT

An automotive vehicle seat (3) with an airbag intended for restraining its occupant (9) in the event of a side impact, comprising a bag (15), including a plurality of cells (31, 33, 35, 37), sized so as to protect the pelvis, abdomen, thorax and head of the occupant, located in the backrest (5) of the seat (3) wrapped in a flexible case and provided with at least two fixing points (25, 27) to fix it to the backrest (5) of the seat (3), which is inflated with the gas provided by a gas generator (17), separated from the bag, through a diffusing tube (19).

### FIELD OF THE INVENTION

The present invention refers to an automotive vehicle seat with an airbag in the backrest thereof intended for restraining the occupant thereof in the event of a side impact.

### BACKGROUND OF THE INVENTION

In the known art the protection of passengers in the front portion of an automotive vehicle in the event of a side impact is performed by means of the following two types of airbag:
An airbag located in the seat or door of the vehicle intended for protecting the thorax or pelvis and thorax of the occupant.
A curtain airbag fixed to the roof of the vehicle intended for protecting the head of the occupant.

In the case of convertible vehicles without a roof, installing curtain airbags could be very problematic if not impossible, as a result of which many such vehicles do not include airbags protecting the head of the occupant.

Another problem of the airbags mentioned is that in the event of seat reclining the head of the occupant may not be protected by the curtain airbag because it would be outside the predefined protection area of the airbag.

On their part, automobile builders are progressively developing seats with narrower structures consequently having increasingly less space in the seat backrest, making placing side airbags difficult.

Airbag proposals are known that are intended for protecting the head and thorax of the occupant such as U.S. Pat. No. 6,168,192 disclosing an airbag formed by a bag folded along the entire length of the seat, housed between an elongated casing and a cover, having the drawback of being expensive given the use of a large casing.

The present invention aims to solve the mentioned drawbacks.

### SUMMARY OF THE INVENTION

The present invention sets forth an automotive vehicle seat with an airbag intended for restraining the occupant thereof in the event of a side impact comprising, as in airbags known in the prior art, a bag placed in the seat backrest which is inflated with the gas provided by a generator and deployed when said impact occurs, going through a predefined breaking area of the seat backrest, being located between the occupant and the vehicle body.

According to the invention, the airbag has the following additional features:
The bag includes a plurality of cells in order to protect the occupant from the pelvis to the head and is located in the seat backrest wrapped in a flexible case. The bag is provided with fixing points through which it is fixed to the seat backrest.
The generator is located apart from the bag, preferably in the back portion of the seat.
The airbag also comprises a diffusing tube distributing the gas provided by the generator to the different cells of the bag.

Amongst the advantages provided by the invention the following can be mentioned:
The pelvis, abdomen, thorax and head are protected with the same airbag.
Since the bag is located in the seat, the protection area for the occupant does not change according to the position of the seat, facilitating the use of moving seats on the part of automobile manufacturers.
The space occupied by the airbag in the seat backrest is reduced both because the space occupied by the generator is freed since it is located apart from the bag, preferably in the back portion of the seat backrest, facilitating the increase in bag size required to protect the occupant from the pelvis to the head and also facilitating seat narrowing.
The airbag has a low cost because instead of a housing casing it uses a flexible case made from a textile material.

Other features and advantages of the present invention will be inferred from the following detailed description of an illustrative and by no means limiting embodiment of the object of the invention according to the attached drawings.

### DESCRIPTION OF THE DRAWINGS

FIG. 1 shows a schematic side sectional view of an automobile seat according to the present invention with the bag of the airbag deployed, showing its division into cells.

FIG. 2 shows a schematic side sectional view of an automobile seat according to the present invention showing that the airbag protection is the same when the seat is reclined.

FIG. 3 shows a schematic perspective view of an automobile seat according to the present invention showing the different airbag components.

FIG. 4 shows a schematic side sectional view of an automobile seat according to the present invention showing the means of fixing the bag of the airbag to the seat.

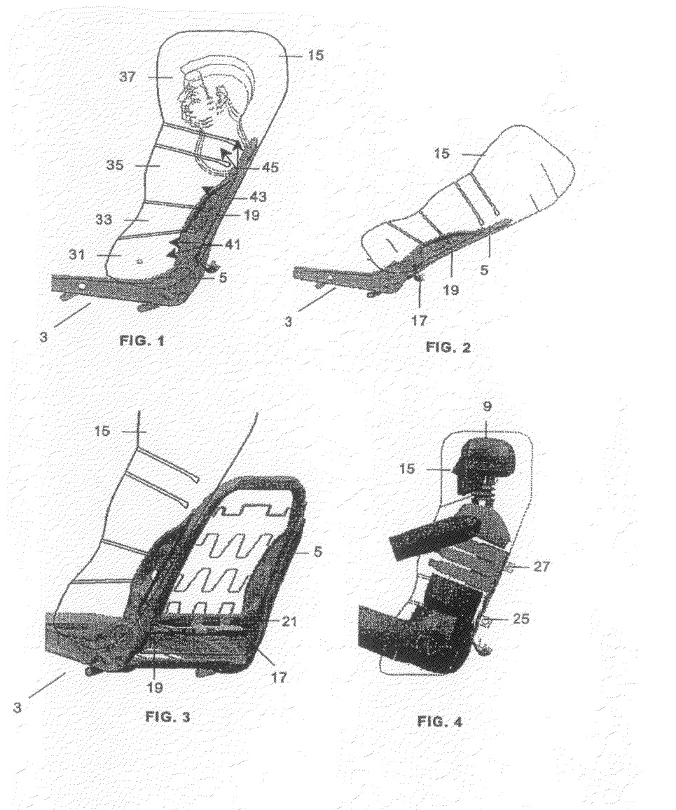

### DETAILED DESCRIPTION OF THE INVENTION

According to the invention the seat 3 comprises an airbag formed by a bag 15, a generator 17 and a diffusing tube 19.

The bag 15, duly folded in order to deploy between the occupant 9 of the seat and the vehicle body and introduced in a flexible case made for example of a textile material is introduced in the side portion of the backrest 5 of the seat 3.

The bag 15 is formed by a layer of fabric folded over itself which is joined, forming different cells 31, 33, 35, 37 sized in order to protect, respectively, the pelvis, abdomen, thorax and head of the occupant 9. Alternatively, the bag may be formed with two layers of fabric joined together, forming cells 31, 33, 35, 37.

The bag 15 is fixed to the seat 3 by means of at least two fixing points 25, 27.

The generator 17 is located in the back portion of the seat 3 in a horizontal direction fixed to the bar 21. It could alternatively be located in another position, although it is always apart from the bag in order to free up space in the backrest 5 of the seat 3.

The diffusing tube 19 carries the gas from the generator 17 to the cells 31, 33, 35, 37 of the bag 15 having distribution ports 41, 43, 45 to that effect.

Although several embodiments of the invention have been described and represented, it is obvious that modifications can be introduced therein that are comprised within its scope, not limiting it to said embodiments but to the content of the following claims.

1. An automotive vehicle seat (3) with an airbag intended for restraining its occupant (9) in the event of a side impact, comprising a bag (15) located in the backrest (5) of the seat (3) which is inflated with the gas provided by the gas generator (17) and deployed when said impact occurs, going through a predefined breaking area of the backrest (5) of the seat (3) being located between the occupant (9) and the vehicle body, characterised in that:
a) the bag (15), including a plurality of cells (31, 33, 35, 37), is located in the backrest (5) of the seat (3) wrapped in a flexible case and provided with at least two fixing points (25, 27) to fix it to the backrest (5) of the seat (3);
b) the generator (17) is apart from the bag (15); and
c) it also comprises a diffusing tube (19) distributing the gas provided by the generator (17) to the cells (31, 33, 35, 37).

2. An automotive vehicle seat (3) according to claim 1, characterised in that the generator (17) is located in the back portion of the seat (3).

3. An automotive vehicle seat (3) according to claim 1, characterised in that the cells (31, 33, 35, 37) are sized so as to protect, respectively, the pelvis, abdomen, thorax and head of the occupant (9).
